(19) United States
(12) Patent Application Publication
(10) Pub. No.: US 2021/0391770 A1
(43) Pub. Date: Dec. 16, 2021

(54) Motor, Apparatus, and Method of Manufacturing Motor

(71) Applicant: ABB Schweiz AG, Baden (CH)

(72) Inventors: Yun Su, Shanghai (CN); Fengqing Lin, Shanghai (CN); Guangming Xie, Shanghai (CN); Lijun Liu, Hangzhou, Zhejiang (CN)

(73) Assignee: ABB Schweiz AG, Baden (CH)

(21) Appl. No.: 17/291,835

(22) PCT Filed: Sep. 10, 2018
(86) PCT No.: PCT/CN2018/104868

§ 371 Date: May 6, 2021

(51) Int. Cl. H02K 9/193; H02K 5/20; H02K 15/14

(52) U.S. Cl. CPC H02K 9/193; H02K 15/14; H02K 5/203

(57) ABSTRACT

A motor comprises a rotor; a stator arranged outside the rotor about a central axis of the rotor; a tubular enclosure arranged outside the stator about the central axis and contacting the stator, the tubular enclosure comprising a fluid channel and circumferential rabbets, the fluid channel extending between a first end and a second end of the tubular enclosure, the circumferential rabbets being arranged at the ends of the tubular enclosure and comprising respective corners; sealing rings arranged at the respective corners of the circumferential rabbets; and a pair of covers coupled to the respective ends of the tubular enclosure by mating with the circumferential rabbets, the pair of covers pressing the respective sealing rings and closing the fluid channel at the ends of the tubular enclosure.

### FIELD

Embodiments of present disclosure generally relate to the field of electrical equipment, and more particularly, to a motor, an apparatus, and a method of manufacturing a rotor.

### BACKGROUND

A motor can generate heat during its operation. In order to ensure that the motor can run properly, it is necessary to dissipate the heat from the motor in time. Conventional cooling modes for the motor include self-cooling, air cooling and water cooling, etc. The water cooling, due to its excellent cooling effect, can make the motor to output higher power at the same cost, or lower the cost of the motor under the same output power. Moreover, noise of the motor during operating under the water cooling mode is lower than the air cooling mode. Therefore, the motor under the water cooling mode has high economic value and practical value in various industries, especially in an occasion where volume and weight of the motor are limited.

Usually, a water cooled enclosure is provided for the motor to dissipate heat from a stator of the motor. A scheme of straight channel enclosure extruded from an aluminum profile has been widely used because of its low cost, wide adaptability and no gas shrinkage hole. However, in this case, it is difficult to seal waterways at two end faces of the enclosure.

There are generally two conventional ways for sealing the waterways of the enclosure. In one way, the end faces of the enclosure are welded with end plates to seal the waterways. However, welding performance of the aluminum profile is generally poor and the cost of the welding is high. Moreover, in this way, quality of the waterways is very difficult to be controlled after the welding. The other way is to use various kinds of sealing parts with complex structure to seal the waterways of the enclosure, rendering the cost of motor generally high.

Therefore, there is a need for a new solution for cooling the motor in a simple, reliable, and cost-effective manner.

### SUMMARY

In a first aspect of the present disclosure, a motor is provided. The motor comprises a rotor; a stator arranged outside the rotor about a central axis of the rotor; a tubular enclosure arranged outside the stator about the central axis and contacting the stator, the tubular enclosure comprising a fluid channel and circumferential rabbets, the fluid channel extending between a first end and a second end of the tubular enclosure, the circumferential rabbets being arranged at the ends of the tubular enclosure and comprising respective corners; sealing rings arranged at the respective corners of the circumferential rabbets; and a pair of covers coupled to the respective ends of the tubular enclosure by mating with the circumferential rabbets, the pair of covers pressing the respective sealing rings and closing the fluid channel at the ends of the tubular enclosure.

In some embodiments, the tubular enclosure further comprises arc grooves arranged at the corners of the circumferential rabbets for receiving the respective sealing rings.

In some embodiments, the circumferential rabbets comprise a first inner circumferential rabbet arranged at the first end of the tubular enclosure and being closer to the central axis than the fluid channel; a first outer circumferential rabbet arranged at the first end of the tubular enclosure and being farther from the central axis than the fluid channel; a second inner circumferential rabbet arranged at the second end of the tubular enclosure and being closer to the central axis than the fluid channel; and a second outer circumferential rabbet arranged at the second end of the tubular enclosure and being farther from the central axis than the fluid channel.

In some embodiments, the first inner circumferential rabbet is arranged outside the first outer circumferential rabbet along the central axis, and the second inner circumferential rabbet is arranged outside the second outer circumferential rabbet along the central axis.

In some embodiments, the tubular enclosure is made from aluminum extrusions.

In some embodiments, the motor further comprises sealing glue arranged between the pair of covers and the circumferential rabbets.

In some embodiments, the fluid channel comprises a plurality of fluid pathways extending in parallel between the ends of the tubular enclosure along the central axis.

In some embodiments, the tubular enclosure further comprises a fluid inlet and a fluid outlet arranged on an outer wall of the tubular enclosure, and the fluid inlet and the fluid outlet are in fluid communication with two adjacent fluid pathways isolated from each other, respectively.

In some embodiments, the other adjacent fluid pathways are connected via recesses arranged between adjacent fluid pathways at the ends of the tubular enclosure, and the fluid channel is S-shaped along a circumferential direction of the tubular enclosure.

In some embodiments, the stator and the tubular enclosure are interference fit with each other.

In some embodiments, the pair of covers comprise bearing chambers adapted to support the rotor through bearings.

In some embodiments, the pair of covers are fastened to the tubular enclosure through screws.

In some embodiments, the sealing rings have circular cross section.

In some embodiments, the fluid channel contains water.

In some embodiments, the motor is a servo motor.

In a second aspect of the present disclosure, an apparatus comprising a motor according to the first aspect of the present disclosure is provided.

In a third aspect of the present disclosure, a method of manufacturing a motor is provided. The method comprises providing a rotor; arranging a stator outside the rotor about a central axis of the rotor; arranging a tubular enclosure outside the stator about the central axis, the tubular enclosure contacting the stator and comprising a fluid channel and circumferential rabbets, the fluid channel extending between a first end and a second end of the tubular enclosure, the circumferential rabbets being arranged at the ends of the tubular enclosure and comprising respective corners; arranging sealing rings at the respective corners of the circumferential rabbets; and coupling a pair of covers to the respective ends of the tubular enclosure by mating with the circumferential rabbets, the pair of covers pressing the respective sealing rings and closing the fluid channel at the ends of the tubular enclosure.

According to various embodiments of the present disclosure, through providing the circumferential rabbets at the ends of the tubular enclosure so as to mate with the covers and arranging the sealing rings at the respective corners of the circumferential rabbets, the fluid channel in the enclosure may be sealed with simple structure reliably. On the other hand, the space of the motor is fully utilized by setting the sealing rings at the corners of the circumferential rabbets. In this way, the radial size of the motor and thus the cost of the motor can be reduced.

### DESCRIPTION OF DRAWINGS

Through the following detailed descriptions with reference to the accompanying drawings, the above and other objectives, features and advantages of the example embodiments disclosed herein will become more comprehensible. In the drawings, several example embodiments disclosed herein will be illustrated in an example and in a non-limiting manner, wherein:

FIG. 1 is a schematic cross sectional view of a motor according to an example embodiment;

FIG. 2 schematically illustrates a tubular enclosure with fluid pathways according to an example embodiment;

FIG. 3 is a partial cross sectional view of the tubular enclosure illustrating details of rabbets according to an example embodiment; and

FIG. 4 is a partial cross sectional view of the rotor illustrating details of sealing structure between the tubular enclosure and a cover according to an example embodiment.

Throughout the drawings, the same or similar reference symbols are used to indicate the same or similar elements.

### DETAILED DESCRIPTION OF EMBODIMENTS

Principles of the present disclosure will now be described with reference to several example embodiments shown in the drawings. Though example embodiments of the present disclosure are illustrated in the drawings, it is to be understood that the embodiments are described only to facilitate those skilled in the art in better understanding and thereby achieving the present disclosure, rather than to limit the scope of the disclosure in any manner.

As discussed above, in a conventional way for sealing the waterways of the enclosure, the welding performance of the aluminum profile is generally poor and the cost of the welding is high; and in another conventional way for sealing the waterways, various kinds of sealing parts with complex structure are needed to seal the waterways of the enclosure, rendering the cost of motor high. According to embodiments of the present disclosure, circumferential rabbets are provided at the ends of the enclosure so as to mate with end covers of the motor and sealing rings are arranged at respective corners of the circumferential rabbets, the fluid channel in the enclosure may be sealed with simple sealing structure reliably.

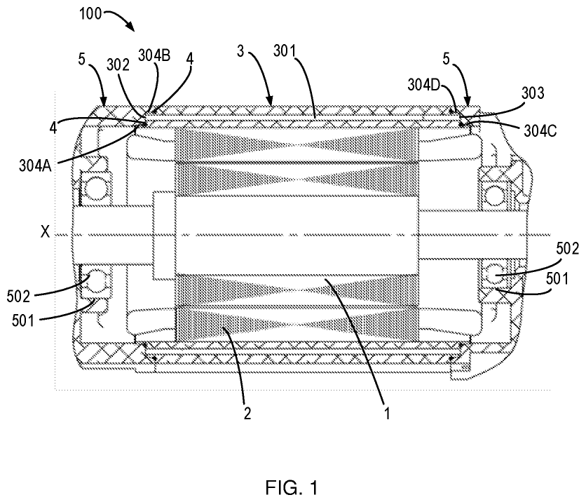

The above idea may be implemented in various manners, as will be described in detail in the following paragraphs. FIGS. 1-4 illustrate example manners for implementing the principles of the present disclosure. Hereinafter, the principles of the present disclosure will be described in detail with reference to FIGS. 1-4.

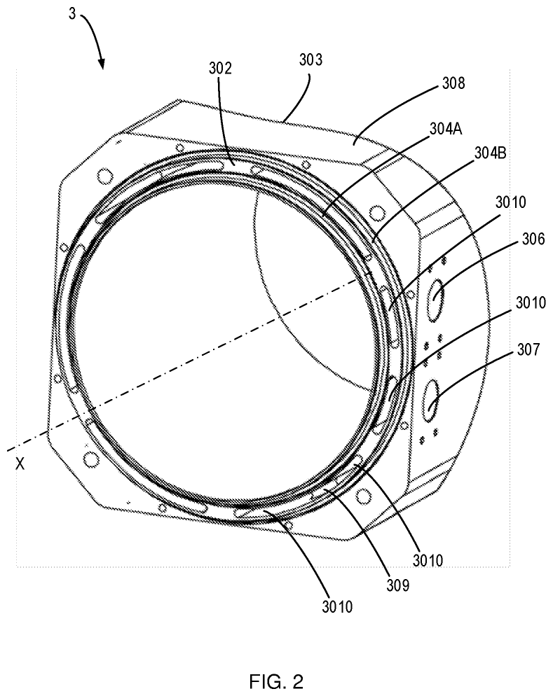

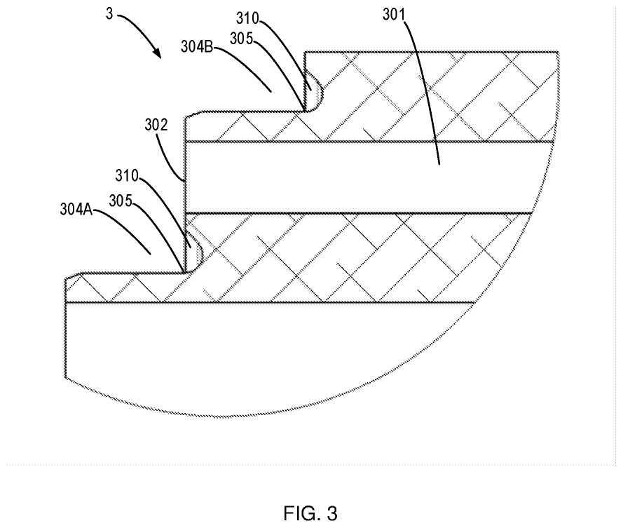

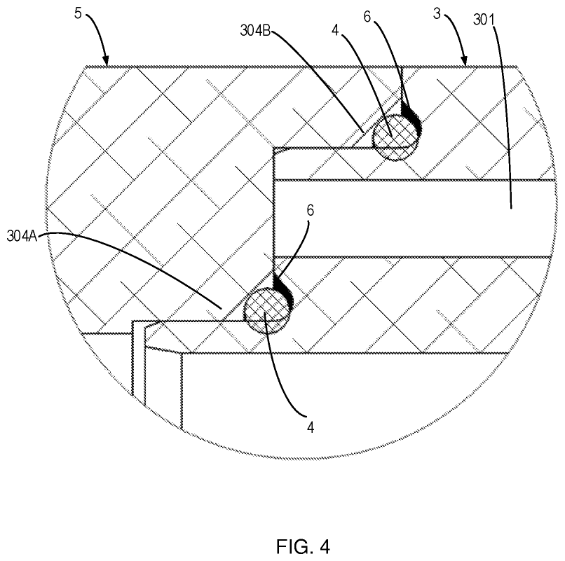

FIG. 1 is a schematic cross sectional view of a motor 100 according to an example embodiment, FIG. 2 schematically illustrates a tubular enclosure 3 with fluid pathways 3010 according to an example embodiment, FIG. 3 is a partial cross sectional view illustrating details of rabbets 304A, 304B of the tubular enclosure 3 according to an example embodiment, and FIG. 4 is a partial cross sectional view of the rotor 100 illustrating details of sealing structure between the tubular enclosure 3 and a cover 5 according to an example embodiment.

As shown in FIGS. 1-4, the motor 100 includes a rotor 1, a stator 2, a tubular enclosure 3, sealing rings 4, and a pair of covers 5. The stator 2 is arranged outside the rotor 1 about a central axis X of the rotor 1. The tubular enclosure 3 is arranged outside the stator 2 about the central axis X and contacts the stator 2. During operation of the motor 100, the stator 2 may generate heat. In order to dissipate the heat from the motor 100 in time, the tubular enclosure 3 is provided with a fluid channel 301. The fluid channel 301 extends between a first end 302 and a second end 303 of the tubular enclosure 3. The first and second ends 302, 303 are opposite to each other along the central axis X.

In an embodiment, the fluid channel 301 may contain water. In this case, the heat generated by the stator 2 may be transferred to the tubular enclosure 3 and dissipated by the water flowing in the fluid channel 301. In other embodiments, the fluid channel 301 may contain other available types of fluids, such as a coolant containing ethylene glycol. The present disclosure does not intend to limit the type of the cooling fluid in the fluid channel 301.

In order to prevent the water from leaking out of the motor 100, the sealing rings 4 are arranged between the ends 302, 303 of the tubular enclosure 3 and the pair of covers 5. As shown in FIGS. 1-4, the tubular enclosure 3 is provided with circumferential rabbets 304A, 304B, 304C, 304D. The circumferential rabbets 304A, 304B, 304C, 304D are arranged at the ends 302, 303 of the tubular enclosure 3 and include respective corners 305. The sealing rings 4 are arranged at the respective corners 305 of the circumferential rabbets 304A, 304B, 304C, 304D. The pair of covers 5 are coupled to the respective ends 302, 303 of the tubular enclosure 3 by mating with the circumferential rabbets 304A, 304B, 304C, 304D. The pair of covers 5 may press the respective sealing rings 4 and close the fluid channel 301 at the ends 302, 303 of the tubular enclosure 3. When fastening the covers 5 onto the ends 302, 303 of the tubular enclosure 3, the sealing rings 4 may be deformed under pressure and thus have sealing effect.

Through providing the circumferential rabbets 304A, 304B, 304C, 304D at the ends 302, 303 of the tubular enclosure 3 so as to mate with the covers 5 and arranging the sealing rings 4 at the respective corners 305 of the circumferential rabbets 304A, 304B, 304C, 304D, the fluid channel 301 in the enclosure 3 may be sealed with simple structure reliably. On the other hand, the space of the motor 100 is fully utilized by setting the sealing rings 4 at the corners 305 of the circumferential rabbets 304A, 304B, 304C, 304D. In this way, the radial size of the motor 100 and thus the cost of the motor 100 can be reduced.

In an embodiment, as shown in FIG. 1, both ends 302, 303 of the tubular enclosure 3 are provided with inner circumferential rabbets 304A, 304C and outer circumferential rabbets 304B, 304D, respectively, to realize sealing both inside and outside of the fluid channel 301. The first inner circumferential rabbet 304A is arranged at the first end 302 of the tubular enclosure 3 and inside the fluid channel 301, i.e., being closer to the central axis X than the fluid channel 301. The first outer circumferential rabbet 304B is arranged at the first end 302 of the tubular enclosure 3 and outside the fluid channel 301, i.e., being farther from the central axis X than the fluid channel 301. Similarly, the second inner circumferential rabbet 304C is arranged at the second end 303 of the tubular enclosure 3 and inside the fluid channel 301. The second outer circumferential rabbet 304D is arranged at the second end 303 of the tubular enclosure 3 and outside the fluid channel 301. In other embodiments, both ends 302, 303 of the tubular enclosure 3 may be provided with more or less circumferential rabbets with respective corners 305, and the sealing rings 4 may be placed at the respective corners 305 of the circumferential rabbets. The present disclosure does not intend to limit the number of the circumferential rabbets arranged at both ends 302, 303 of the tubular enclosure 3.

In an embodiment, as shown in FIG. 1, the first inner circumferential rabbet 304A is arranged outside the first outer circumferential rabbet 304B along the central axis X. Similarly, the second inner circumferential rabbet 304C is arranged outside the second outer circumferential rabbet 304D along the central axis X. With such an arrangement, the covers 5 may be easily mounted on the ends 302, 303 of the tubular enclosure 3 by mating with these circumferential rabbets 304A, 304B, 304C, 304D. In another embodiment, the first inner circumferential rabbet 304A may be arranged inside the first outer circumferential rabbet 304B along the central axis X, and the second inner circumferential rabbet 304C may be arranged inside the second outer circumferential rabbet 304D along the central axis X. In other embodiments, the circumferential rabbets 304A, 304B, 304C, 304D may have other relative arrangement. The present disclosure does not intend to limit the relative arrangement of the circumferential rabbets 304A, 304B, 304C, 304D.

In an embodiment, as shown in FIG. 3, the tubular enclosure 3 further includes arc grooves 310 arranged at the corners 305 of the circumferential rabbets 304A, 304B, 304C, 304D. The grooves 310 are provided for receiving and holding the respective sealing rings 4. When fastening the covers 5 onto the ends 302, 303 of the tubular enclosure 3, the sealing rings 4 may be partially pressed into the respective arc grooves 310. With such an arrangement, the size of the tubular enclosure 3 and thus the cost of the motor 100 can be further reduced.

In an embodiment, the tubular enclosure 3 is made from aluminum extrusions. In this way, the manufacturing mold is simple and the manufacturing procedure is convenient. In other embodiments, the tubular enclosure 3 may be made from other materials or by other manufacturing processes. The present disclosure does not intend to limit the material and manufacturing process of the tubular enclosure 3.

In an embodiment, as shown in FIG. 4, sealing glue 6 is arranged between the pair of covers 5 and the circumferential rabbets 304A, 304B, 304C, 304D. With combination of the sealing rings 4 and the sealing glue 6, the sealing performance of the motor 100 may be further improved.

In an embodiment, as shown in FIG. 2, the fluid channel 301 may include a plurality of fluid pathways 3010 extending in parallel between the ends 302, 303 of the tubular enclosure 3 along the central axis X. The pathways 3010 may be uniformly arranged in the tubular enclosure 3 along its circumferential direction. That is, the distances between adjacent pathways 3010 may be substantially the same as each other. In this way, the water in the fluid channel 301 can evenly dissipate the heat generated by the stator 2 at different positions across the tubular enclosure 3.

In an embodiment, as shown in FIG. 2, the tubular enclosure 3 further includes a fluid inlet 306 and a fluid outlet 307 arranged on an outer wall 308 of the tubular enclosure 3. The fluid inlet 306 and the fluid outlet 307 are in fluid communication with two adjacent fluid pathways 3010 isolated from each other, respectively. The other adjacent fluid pathways 3010 are connected via recesses 309 arranged between adjacent fluid pathways 3010 at the ends 302, 303 of the tubular enclosure 3. With such an arrangement, a S-shaped fluid channel 301 may be formed along the circumferential direction of the tubular enclosure 3. The water may flow into the S-shaped fluid channel 301 via the fluid inlet 306 and out of the S-shaped fluid channel 301 via the fluid outlet 307. The S-shaped fluid channel 301 provides a long fluid path. Thus, the cooling performance of the fluid channel 301 is relatively high.

In an embodiment, the stator 2 and the tubular enclosure 3 are interference fit with each other. Through the interference fit, the heat generated by the stator 2 may be transferred to the tubular enclosure 3 quickly.

In an embodiment, as shown in FIG. 1, the pair of covers 5 may include bearing chambers 501 for supporting the rotor 1 through bearings 502. Since the covers 5 are mounted at the ends 302, 303 of the tubular enclosure 3, the cooling fluid in the fluid channel 301 also has a cooling effect on the covers 5 in addition to cool the stator 2. In this way, the bearings 502 mounted in the bearing chambers 501 may be cooled indirectly. Thus, the heat dissipation performance of the motor 100 may be further improved.

In an embodiment, the pair of covers 5 are fastened to the tubular enclosure 3 through screws uniformly distributed along the circumferential direction of the tubular enclosure 3. When fastening the covers 5 onto the ends 302, 303 of the tubular enclosure 3 through the screws, the sealing rings 4 may be deformed under pressure.

In an embodiment, the sealing rings 4 may have circular cross section. In other, the sealing rings 4 may also have other cross-section shape. The present disclosure does not intend to limit the cross-section shape of the sealing rings 4.

In an embodiment, the motor 100 is a servo motor. In other embodiments, the motor 100 may be of other types. The present disclosure does not intend to limit the type of the motor 100.

The motor 100 as described above may be used in various industrial apparatus, such as industrial robots, machine tools, and textile devices.

In an embodiment according to the present disclosure, a method of manufacturing a motor 100 is provided. The method may include: providing a rotor 1; arranging a stator 2 outside the rotor 1 about a central axis X of the rotor 1; arranging a tubular enclosure 3 outside the stator 2 about the central axis X, the tubular enclosure 3 contacting the stator 2 and comprising a fluid channel 301 and circumferential rabbets 304A, 304B, 304C, 304D, the fluid channel 301 extending between a first end 302 and a second end 303 of the tubular enclosure 3, the circumferential rabbets 304A, 304B, 304C, 304D being arranged at the ends 302, 303 of the tubular enclosure 3 and comprising respective corners 305; arranging sealing rings 4 at the respective corners 305 of the circumferential rabbets 304A, 304B, 304C, 304D; and coupling a pair of covers 5 to the respective ends 302, 303 of the tubular enclosure 3 by mating with the circumferential rabbets 304A, 304B, 304C, 304D, the pair of covers 5 pressing the respective sealing rings 4 and closing the fluid channel 301 at the ends 302, 303 of the tubular enclosure 3.

It is noted that the embodiments as described above with respect to the motor 100 may be incorporated into the method of manufacturing the motor 100.

It should be appreciated that the above detailed embodiments of the present disclosure are only to exemplify or explain principles of the present disclosure and not to limit the present disclosure. Therefore, any modifications, equivalent alternatives and improvement, etc. without departing from the spirit and scope of the present disclosure shall be included in the scope of protection of the present disclosure. Meanwhile, appended claims of the present disclosure aim to cover all the variations and modifications falling under the scope and boundary of the claims or equivalents of the scope and boundary.

1. A motor, comprising:
a rotor;
a stator arranged outside the rotor about a central axis of the rotor;
a tubular enclosure arranged outside the stator about the central axis and contacting the stator, the tubular enclosure comprising a fluid channel and circumferential rabbets, the fluid channel extending between a first end and a second end of the tubular enclosure, the circumferential rabbets being arranged at the ends of the tubular enclosure and comprising respective corners;
sealing rings arranged at the respective corners of the circumferential rabbets; and
a pair of covers coupled to the respective ends of the tubular enclosure by mating with the circumferential rabbets, the pair of covers pressing the respective sealing rings and closing the fluid channel at the ends of the tubular enclosure.

2. The motor according to claim 1, wherein the tubular enclosure further comprises arc grooves arranged at the corners of the circumferential rabbets for receiving the respective sealing rings.

3. The motor according to claim 1, wherein the circumferential rabbets comprise:
a first inner circumferential rabbet arranged at the first end of the tubular enclosure and being closer to the central axis than the fluid channel;
a first outer circumferential rabbet arranged at the first end of the tubular enclosure and being farther from the central axis than the fluid channel;
a second inner circumferential rabbet arranged at the second end of the tubular enclosure and being closer to the central axis than the fluid channel; and
a second outer circumferential rabbet arranged at the second end of the tubular enclosure and being farther from the central axis than the fluid channel.

4. The motor according to claim 3, wherein the first inner circumferential rabbet is arranged outside the first outer circumferential rabbet along the central axis, and the second inner circumferential rabbet is arranged outside the second outer circumferential rabbet along the central axis.

5. The motor according to claim 1, wherein the tubular enclosure is made from aluminum extrusions.

6. The motor according to claim 1, further comprising sealing glue arranged between the pair of covers and the circumferential rabbets.

7. The motor according to claim 1, wherein the fluid channel comprises a plurality of fluid pathways extending in parallel between the ends of the tubular enclosure along the central axis.

8. The motor according to claim 7, wherein the tubular enclosure further comprises a fluid inlet and a fluid outlet arranged on an outer wall of the tubular enclosure, and the fluid inlet and the fluid outlet are in fluid communication with two adjacent fluid pathways isolated from each other, respectively.

9. The motor according to claim 8, wherein the other adjacent fluid pathways are connected via recesses arranged between adjacent fluid pathways at the ends of the tubular enclosure, and the fluid channel is S-shaped along a circumferential direction of the tubular enclosure.

10. The motor according to claim 1, wherein the stator and the tubular enclosure are interference fit with each other.

11. The motor according to claim 1, wherein the pair of covers comprise bearing chambers adapted to support the rotor through bearings.

12. The motor according to claim 1, wherein the pair of covers are fastened to the tubular enclosure through screws.

13. The motor according to claim 1, wherein the sealing rings have circular cross section.

14. The motor according to claim 1, wherein the fluid channel contains water.

15. The motor according to claim 1, wherein the motor is a servo motor.

16. An apparatus comprising a motor according to claim 1.

17. A method of manufacturing a motor, comprising:
providing a rotor;
arranging a stator outside the rotor about a central axis of the rotor;
arranging a tubular enclosure outside the stator about the central axis, the tubular enclosure contacting the stator and comprising a fluid channel and circumferential rabbets, the fluid channel extending between a first end and a second end of the tubular enclosure, the circumferential rabbets being arranged at the ends of the tubular enclosure and comprising respective corners;
arranging sealing rings at the respective corners of the circumferential rabbets; and
coupling a pair of covers to the respective ends of the tubular enclosure by mating with the circumferential rabbets, the pair of covers pressing the respective sealing rings and closing the fluid channel at the ends of the tubular enclosure.
